(19) United States
(12) Patent Application Publication
(10) Pub. No.: US 2006/0137160 A1
(43) Pub. Date: Jun. 29, 2006

(54) Mounting tool for dustproof shield

(76) Inventors: Chin Shen Chung, Taichung City (TW); Chin Chung, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/023,483

(22) Filed: Dec. 29, 2004

(51) Int. Cl. B23P 19/04

(52) U.S. Cl. 29/259

(57) ABSTRACT

A mounting tool for dustproof shield, including a bracket body having two extending arms. A bridge section is interconnected between two ends of the two extending arms, whereby the bracket body is substantially U-shaped. A threaded bush is disposed on the center of the bridge section, through which a threaded rod is screwed. One end of the threaded rod extends out of the bracket body and has a tool connecting section. The other end of the threaded rod is connectable with a conic barrel by means of a fast connector.

### BACKGROUND OF THE INVENTION

The present invention is related to a mounting tool for dustproof shield, and more particularly to a tool for fitting a vehicle-used dustproof shield on the transmission shaft. The mounting tool includes a U-shaped bracket and a conic expander for expanding the small fitting hole of the dustproof shield. A threaded rod is drivable by a driving tool for quickly mounting the dustproof shield.

The transmission shaft of a vehicle has two universal joints at two ends for driving the wheels. Each universal joint is covered by a dustproof shield for protecting the universal joint. The conventional dustproof shield is a conic member having a small fitting hole. When fitting the dustproof shield onto the transmission shaft, it is necessary to first expand the small fitting hole of the dustproof shield for passing through the universal joint. Then the dustproof shield is bounded on the transmission shaft. FIG. 7 shows the existent installation of the dustproof shield. First, the dustproof shield 6 is reversed and fitted onto upper end of a conic barrel 61. Then both hands 62 are inserted into the dustproof shield 6 to push the dustproof shield 6 to lower end of the conic barrel 61. Accordingly, the small fitting hole 63 is forcedly expanded to enlarge the diameter of the small fitting hole 63 into a size larger than the universal joint. However, when the diameter of the small fitting hole 63 is enlarged to the maximum size, it is hard for the worker to remove both hands 62 without rebounding of the dustproof shield 6. Also, it is hard for the worker to push the dustproof shield 6 and tightly bind the dustproof shield 6 on the transmission shaft. As a result, the repairmen often deem replacement of the dustproof shield 6 a task.

Therefore, it is tried by the applicant to develop a mounting tool enabling a worker to more conveniently replace the dustproof shield.

### SUMMARY OF THE INVENTION

It is therefore a primary object of the present invention to provide a mounting tool for dustproof shield. The mounting tool includes a U-shaped bracket and a conic expander for expanding the small fitting hole of the dustproof shield. A threaded rod is drivable by a driving tool for forcedly supporting the conic barrel. After the small fitting hole passes through the universal joint, the driving tool reversely pulls out the conic barrel, whereby the small fitting hole restores to its original size. Therefore, the replacement of the dustproof shield can be easily and quickly completed.

According to the above object, the mounting tool for dustproof shield of the present invention includes a bracket body having two extending arms. A bridge section is interconnected between two ends of the two extending arms, whereby the bracket body is substantially U-shaped. A threaded bush is disposed on the center of the bridge section, through which a threaded rod is screwed. One end of the threaded rod extends out of the bracket body and has a tool connecting section. The other end of the threaded rod is connectable with a conic barrel by means of a fast connector.

The present invention can be best understood through the following description and accompanying drawings wherein:

### BRIEF DESCRIPTION OF THE DRAWINGS

FIG. 1 is a perspective view of the present invention;

FIG. 2 is a perspective view showing the use of the present invention in a first state;

FIG. 3 is a perspective view showing the use of the present invention in a second state;

FIG. 4 is a perspective view showing the use of the present invention in a third state;

FIG. 5 is a perspective view showing the use of the present invention in a fourth state;

FIG. 6 is an enlarged sectional of the fast connector of the present invention; and

FIG. 7 shows the replacement of the existent dustproof shield.

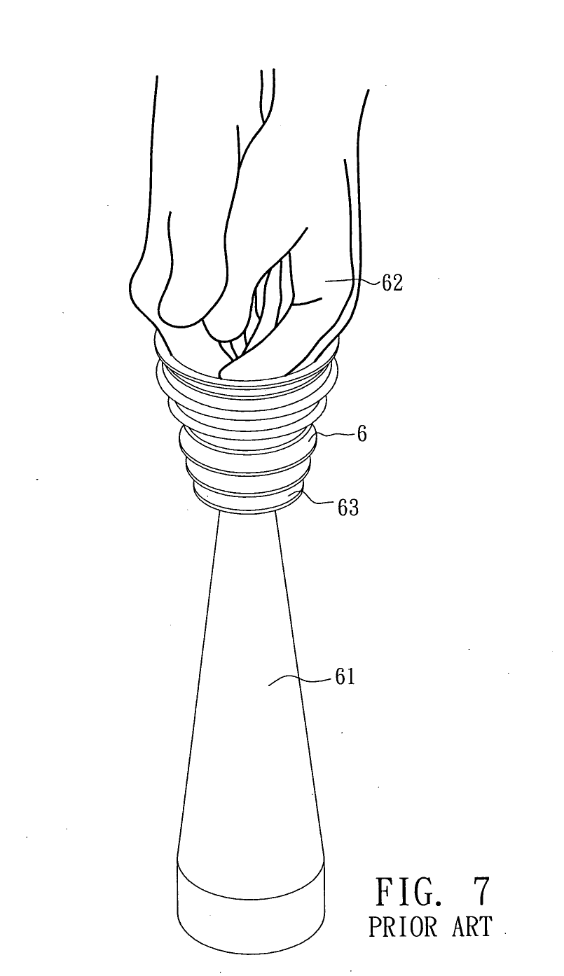

### DETAILED DESCRIPTION OF THE PREFERRED EMBODIMENT

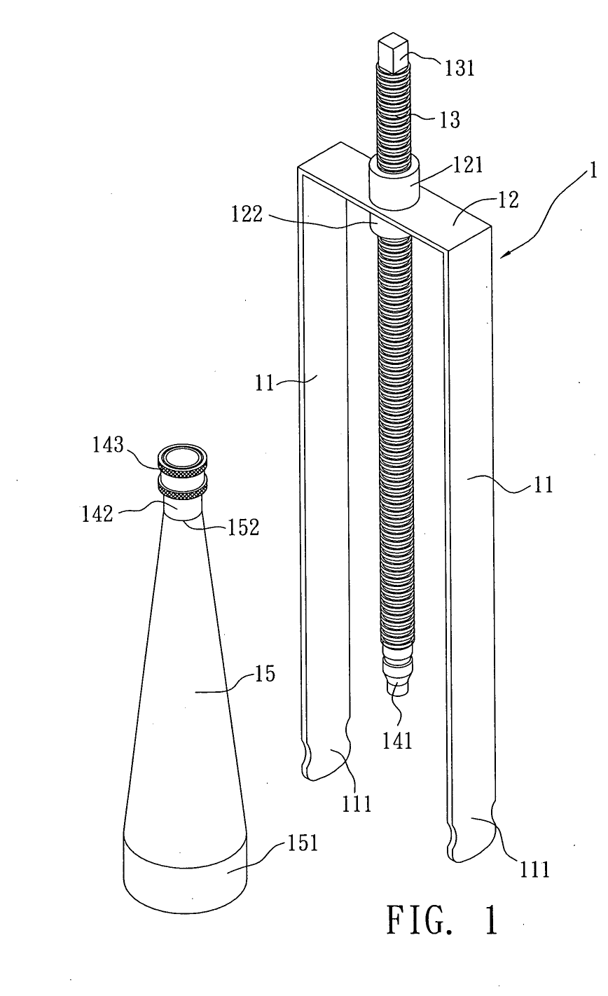

Please refer to FIG. 1. The mounting tool for dustproof shield of the present invention includes a bracket body 1 having two extending arms 11. A bridge section 12 is interconnected between two ends of the two extending arms 11, whereby the bracket body 1 is substantially U-shaped. In this embodiment, a front end of each extending arm 11 distal from the bridge section 12 is formed with an arced section 111. A threaded bush 121 is disposed on the center of the bridge section 12, through which a threaded rod 13 is screwed. One end of the threaded rod 13 extends out of the bracket body 1 and has a tool connecting section 131 connectable with and drivable by a driving tool 2. In this embodiment, the driving tool 2 is a pneumatic tool or an electric tool. The other end of the threaded rod 13 is connected with a conic barrel 15 by means of a fast connector 14. The conic barrel 15 has a large diameter section 151 and a small diameter section 152. In this embodiment, the fast connector 14 includes a male connector 141 disposed at one end of the threaded rod 13 and a female connector 142 disposed on the small diameter 152 of the conic barrel 15. A coupling press ring 143 is disposed on outer circumference of the female connector 142. A collar 122 is disposed under the bridge section 12 of the bracket body 1 corresponding to the coupling press ring 143.

By means of the present invention, the dustproof shield 3 is replaced in the following manner:

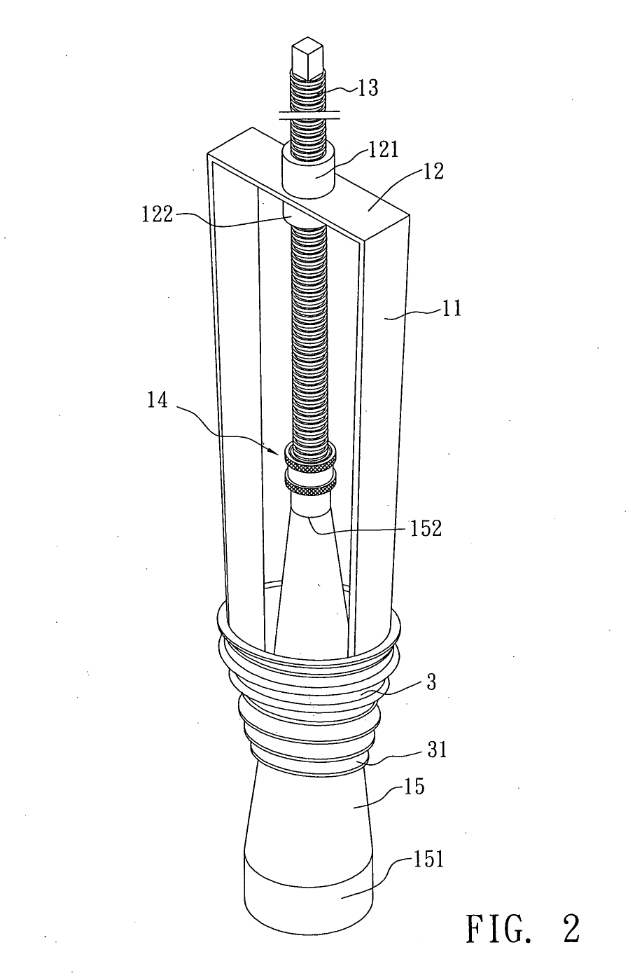

A lubricant is first painted on the surface of the conic barrel 15. Then the small fitting hole 31 of the dustproof shield 3 is reversed and fitted onto the small diameter sect ion 152 of the conic barrel 15 as shown in FIG. 2. Then the front ends of the two extending arms 11 of the bracket body 1 are inserted into the inner circumference of the dustproof shield 3. Then the bracket body 1 is pushed and pressed to downward move the dustproof shield 3 along the large diameter section 151 of the conic barrel 15 so as to forcedly expand the small fitting hole 31 of the dustproof shield 3 and enlarge the diameter of the small fitting hole 31.

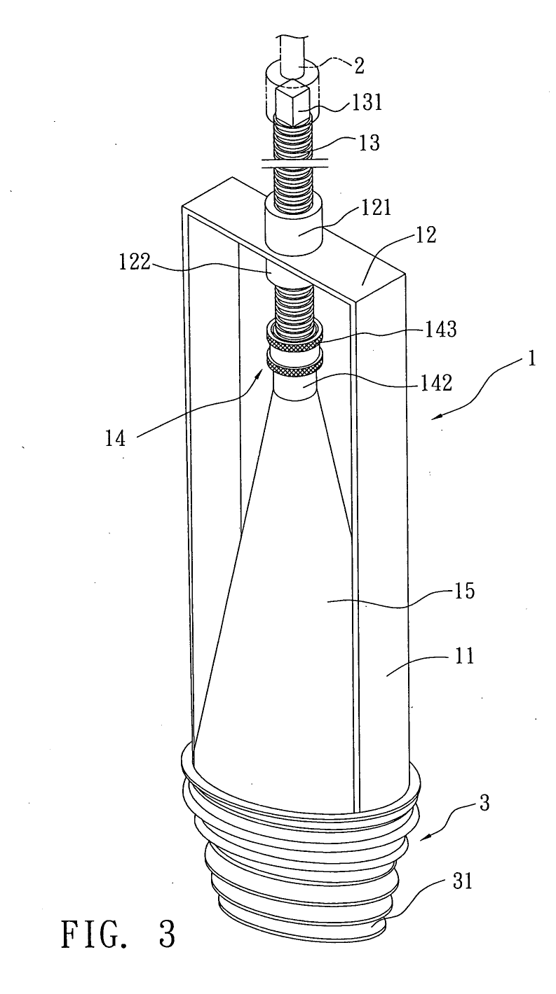

The driving tool 2 is coupled with the tool connecting section 131 of the threaded rod 13. Then the driving tool 2 is activated to drive the threaded rod 13. At this time, the threaded rod 13 is moved toward the conic barrel 15. Accordingly, the male connector 141 of the bottom end of the threaded rod 13 is latched in the female connector 142 of the conic barrel 15 to provide a supporting force for preventing the expanded dustproof shield 3 from contracting toward the small diameter section 152 of the conic barrel 15 as shown in FIG. 3.

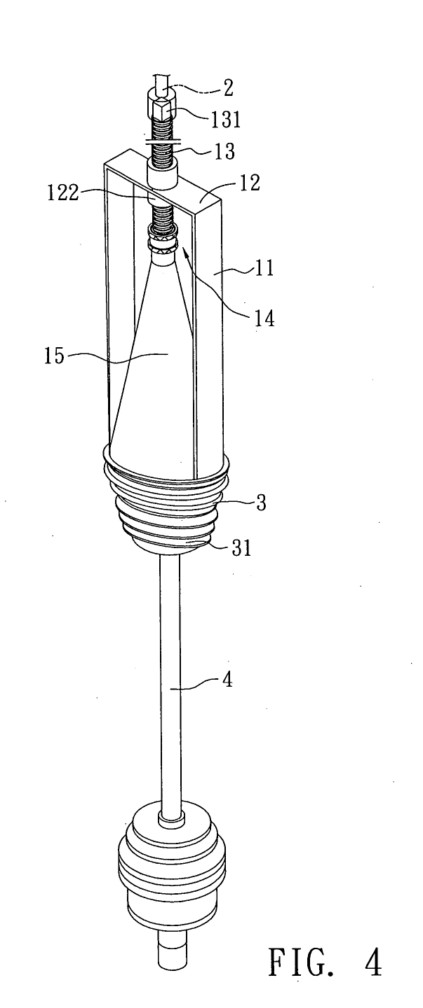

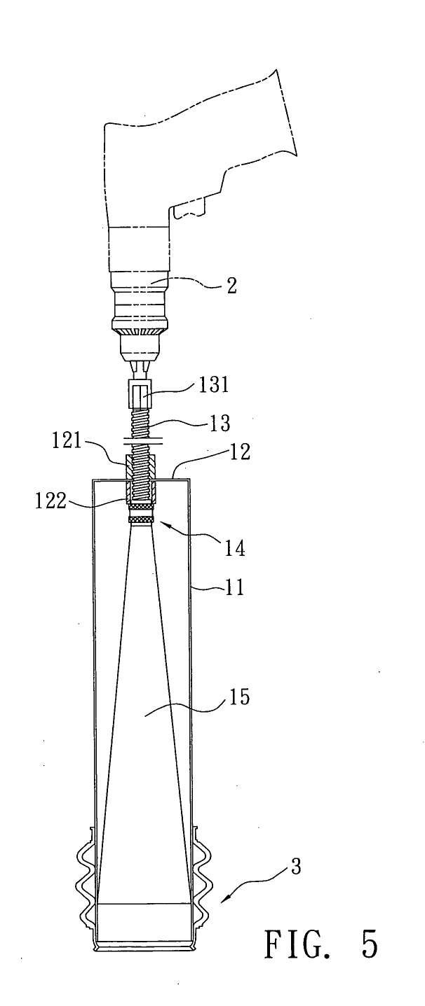

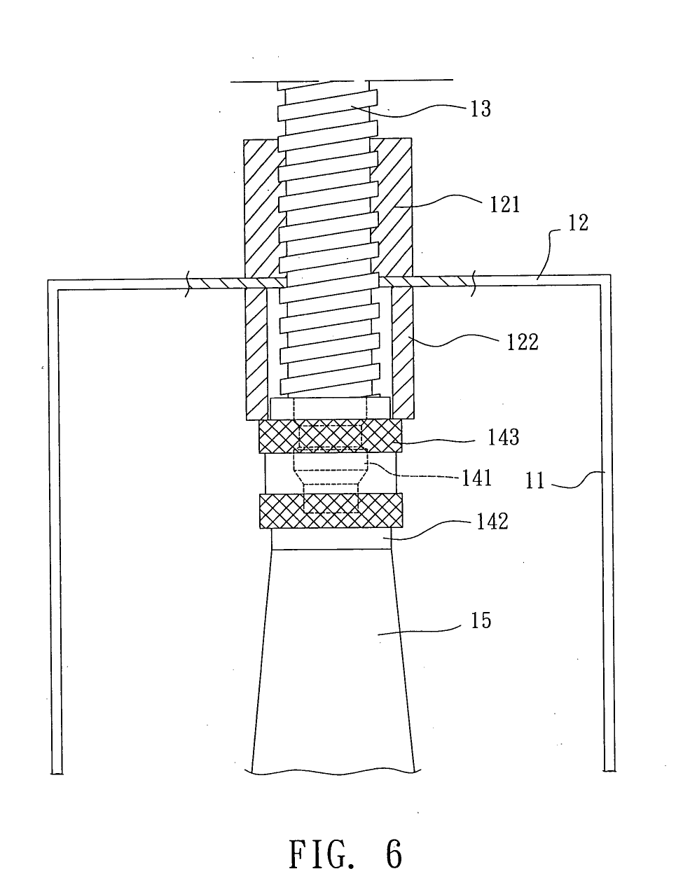

Then the dustproof shield 3 and the bracket body 1 are moved to the position of the transmission shaft 4. The large diameter section 151 of the conic barrel 15 is fitted onto the universal joint at rear end of the transmission shaft 4 as shown in FIG. 4. At this time, the driving tool 2 is again activated to rotate the threaded rod 13 in reverse direction so as to pull back the conic barrel 15 away from the universal joint and separate the conic barrel 15 from the front end of the bracket body 1 as shown in FIGS. 5 and 6. When the conic barrel 15 is totally separated from the dustproof shield 3, the small fitting hole 31 of the dustproof shield 3 will resiliently restore and contract into the original size. Under such circumstance, the dustproof shield 3 is totally fitted on the shaft rod of the transmission shaft 4 to complete the replacement of the dustproof shield 3.

When the bracket body 1 is removed, the threaded rod 13 can be continuously reversely rotated until the coupling press ring 143 of the female connector 142 touches the collar 122 under the bridge section 12 of the bracket body 1. At this time, the coupling press ring 143 is pushed downward so as to separate the male connector 141 from the female connector 142. Finally, the conic barrel 15 is separated from the threaded rod 13 and the conic barrel 15 can be removed. The successive operation is not included in the scope of the present invention and will not be further described hereinafter.

The above embodiment is only used to illustrate the present invention, not intended to limit the scope thereof. Many modifications of the above embodiment can be made without departing from the spirit of the present invention.

What is claimed is:

1. A mounting tool for dustproof shield, comprising a bracket body having two extending arms, a bridge section being interconnected between two ends of the two extending arms, whereby the bracket body is substantially U-shaped, a threaded bush being disposed on the center of the bridge section, through which a threaded rod is screwed, one end of the threaded rod extending out of the bracket body and having a tool connecting section, the other end of the threaded rod being connectable with a conic barrel by means of a fast connector.

2. The mounting tool for the dustproof shield as claimed in claim 1, wherein the fast connector includes a male connector disposed at one end of the threaded rod and a female connector disposed on a small diameter of the conic barrel, whereby the threaded rod can be quickly connected with the conic barrel.

3. The mounting tool for the dustproof shield as claimed in claim 2, wherein a coupling press ring is disposed on outer circumference of the female connector, a collar being disposed under the bridge section of the bracket body corresponding to the coupling press ring.

4. The mounting tool for the dustproof shield as claimed in claim 2, wherein a front end of each extending arm distal from the bridge section is formed with an arced section for abutting against front end of the dustproof shield.
